(19) United States
(12) Patent Application Publication
(10) Pub. No.: US 2005/0236116 A1
(43) Pub. Date: Oct. 27, 2005

(54) Method for protection of a surface struck by an object upon a selected surface portion

(75) Inventors: Hans Bartkuhn, Buchholz (DE); Jens Craney, Melle (DE)

Correspondence Address: HENRY M FEIEREISEN, LLC, 350 FIFTH AVENUE, SUITE 4714, NEW YORK, NY, 10118, US

(73) Assignee: TROODON INTERNATIONAL GMBH, Hamburg (DE)

(21) Appl. No.: 11/028,949

(22) Filed: Jan. 4, 2005

(30) Foreign Application Priority Data
Jan. 8, 2004 (DE) 10 2004 001 303.9

(51) Int. Cl. E05F 11/00

(52) U.S. Cl. 160/191

(57) ABSTRACT

In a method for protecting a surface from impact a selected surface portion of the surface, which may encounter an impact by an object is inserted in a yielding manner in the surface. When the surface portion is knocked out of the surface in the event of the impact, the surface portion can then be reinserted and connected to the surface.

The invention relates to a method for protection of a surface struck by an object upon a selected surface portion.

Furthermore, the invention relates to a door for separating neighboring spaces with a door surface arranged moveably between the spaces to thereby clear or close an access between the spaces in dependence on its respective position.

Surfaces, for example, fencings, are oftentimes placed transversely to existing roadways. Road users only hesitantly get accustomed to the changed situation so that it is not uncommon that an approaching vehicle hits the surface, thereby causing significant damage to the surface as well as to the crashing vehicle. These damages especially affect doors which close spaces of all kind, in particular storage spaces which can be traveled by vehicles, and wash spaces for cleaning vehicles. These damages are especially caused by a driver of a vehicle who either misses the surface unknown to him heretofore or fails to wait for an opening of the door, or at least for a complete opening of the door which, for example, opens upwards in vertical direction. As a result, damages to the door occur, especially when a highly loaded truck with its stacked load fails to wait for the opening of the door to fully clear so that at least the lower region of the door gets damaged.

It is therefore an object of the present invention to improve the method as mentioned above so that the surface suffers only slight damage, when struck, and can be repaired in a relatively easy fashion.

This object is attained in accordance with the invention by fitting the selected surface portion in a yielding manner in the surface in the direction of the impacting object and allowing the surface portion after being knocked out as a result of an impact to be reinserted and connected therewith.

This method is able to limit the damage either to the area affected by the impact of the object or only to the connection existing between the surface portion and the surface. Thus, there is no need to undertake the very costly replacement of the entire surface. In many cases, the surface portion being broken out from the surface can easily be reinserted in the surface.

With respect to the door, the object is attained by providing in the door surface in the direction of an object moving toward the entrance a selected surface portion which is secured in the door surface in a yielding manner so as to separate from the door surface in the event of an impact by an object.

The damage in this type of door is also limited in most cases to the replacement of the connecting means required to rejoin the surface portion in the door surface. Rejoining of the surface portion can be executed fairly easily, allowing quick repair of the entire door. Users attach great importance to the promptness the door can be repaired because the door may possibly be used to close a hall which houses very precious goods so that the risk of theft is significant. Another reason for rapidly restoring the use of the door is the fact that the goods stockpiled behind the door are very often extremely sensitive to the environment, thus absolutely requiring their protection from weather influences.

According to a preferred embodiment of the invention, the surface is deformed in the region of its transition in the surface portion in the event of an impact of the object. As a result of this deformation, the remaining surface as well as the surface portion is left unscathed by the impact. By replacing the connections used in the transition region, the integrity of the entire surface can be restored in a fast and relatively inexpensive manner.

Accordingly, a connecting means, which is easy to replace, is deformed in the event of an impact in the region of the transition, and replaced by proper connecting means, when the surface portion is reinserted. These proper connecting means can be stocked so that, soon after their destruction, a new connecting means can be placed between the surface and the surface portion, and the entire surface can resume the expected tasks.

According to a further preferred embodiment of the invention, the surface portion damaged by the impact can be replaced by a replacement portion. Such replacement portions can be stocked so that a replacement surface can be quickly integrated in the surface, in case of need.

According to a further preferred embodiment of the invention, in doors that have elements to move relative to one another in opening direction, at least one element has two end zones respectively guided in a rail and shortened by an end, a field element is secured to each of both sides of a surface portion remaining of the element for receiving a desired break point and is connected via the desired break point with an end cap which is mechanically connected to an element, arranged above or, optionally below, and is guided in the neighboring rail. Equally applicable are sections or elements which extend in vertical direction and have ends respectively extending in an upper and lower rail oriented in horizontal direction.

Regardless whether individual sections or elements of sectional doors and rolling gates extend in horizontal or vertical direction, remaining surface portions can be quickly repaired if especially urgent need is demanded. These sectional doors and rolling gates are provided in great numbers for closing storage depots and production halls. Environmental impacts must be eliminated when sensitive goods or precise production lines are involved so that a damaged door must be effectively replaced as quickly as possible.

According to a further preferred embodiment of the invention, the surface portion that got knocked out from the door surface can be reinserted in the door surface after removing the object. The surface portion is not destroyed in the event of an impact by the object but can be used again. Thus, the surface portion is knocked out from the door surface when a predetermined impact force of the object is exceeded, without encountering a destruction of the surface portion by the impact.

The latter is held to the door surface when knocked out so as to be prevented from dropping from a great height onto the ground and thereby get damaged.

According to a further preferred embodiment of the invention, the surface portion is connected via a desired break point with the door surface. This desired break point is dimensioned so as to allow a detachment of the surface portion before it gets damaged by the impact of the object.

According to a further preferred embodiment of the invention, the desired break point is configured in the form of a web extending between neighboring edges of the door surface, on one hand, and the surface portion, on the other hand, and rupturing when the predetermined impact force of the object is exceeded. This desired break point can be suited substantially to the prevailing conditions so as to match the impacting object as well as the materials of the door surface.

According to a further preferred embodiment of the invention, the web has two opposite ends of thickened cross sections, each of which is respectively guided in respective recesses of the door surface and the surface portion. Such a web can be made cheaply and easily and can be stocked so as to be immediately available in case of need.

According to a further preferred embodiment of the invention, the web is provided on both its ends with thickenings of circular cross section. Matching this circular cross section is a circular configuration provided for receiving the desired break point in the edges of the door surface and the surface portion. These receptacles are easy to make and allow a quick assembly of the desired break point after impact.

According to a further preferred embodiment of the invention, the web with its thickened ends forms a cross section of a slat which extends through neighboring edges of the surface portion, on one hand, and the door surface, on the other hand. Such slats are easy to insert in the existing recesses so that assembly can be concluded after a very brief time.

The exchange process can be further accelerated by providing the edges of the door surface as well as of the surface portion with semicircular recesses, which form with semicircular recesses of clamping pieces in the two opposing edges of the door surface, on one hand, and the surface portion, on the other hand, circular guides for receiving the circularly thickened ends of the webs. By using the clamping pieces, the slats, provided with the two thickened ends of the webs, can easily be used for construction of the desired break point.

The door surface of sectional doors and rolling gates is comprised of sections which move relative to one another and which are movably guided on at least one vertical rail below a ceiling of one of both spaces and configured in their midsection as a surface portion connected via desired break points with their end caps. In such sections, the subdivision into surface portions and end caps is especially appropriate because the end caps are able to maintain their guidance in the provided rails without being influenced by the impact. The surface portion can be connected quickly and easily with these end caps via the desired break points. At least one section forming the sectional door or an element forming the rolling door is provided with a surface portion which yields to pressure and is connected via a respective desired break point to end caps which bound the section or element on both sides. Thus, the desired break points can be suited in a simple manner to the respectively existing material pairing of end caps, on one hand, and surface portions, on the other hand, so that respective dimensions of the desired break point ensure in any case that the guides for the desired break point remain unscathed when the surface portion breaks off.

According to a further preferred embodiment of the invention, the end cap of each section or each element can be respectively slowed down by a locking brake within a door frame. This ensures that the entire sectional door or rolling door, even when the surface portion knocked out, does not move inadvertently as a consequence of the reduced weight of the section or element made lighter by the surface portion.

According to a further preferred embodiment of the invention, a trigger is released and gets jammed in the desired break point, when the desired break point ruptures, and is releasably connected with a spring that actuates the locking brake. The trigger ensures that the locking brake causes only a fixation of the entire sectional door or rolling gate when encountering a break of the desired break point. For that reason, the trigger of electrically operated sectional doors and rolling gates actuates simultaneously an electric switch by which the electric drive is switched off. Thus, the entire system is held without power and can be repaired quickly and carefully.

According to a further preferred embodiment of the invention, each surface portion is protected against deformation as a result of an impacting object at least on one side by an armoring which is insensitive to shock. Suitably, the armoring is realized by a plastic plate. A suitable plastic is a product known under the trademark Markrolon. This further ensures that the entire sectional door or rolling gate can be made operational again after reinsertion of the desired break point.

Further details of the invention are referred to in the following comprehensive description and attached drawings in which a preferred embodiment of the invention is illustrated by way of example.

The drawings show in:

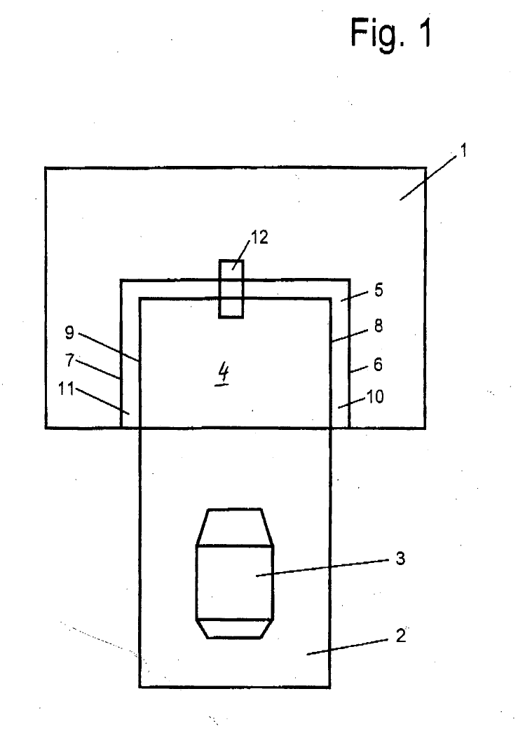

FIG. 1 a plan view of a surface with a surface portion placed in the course of a roadway,

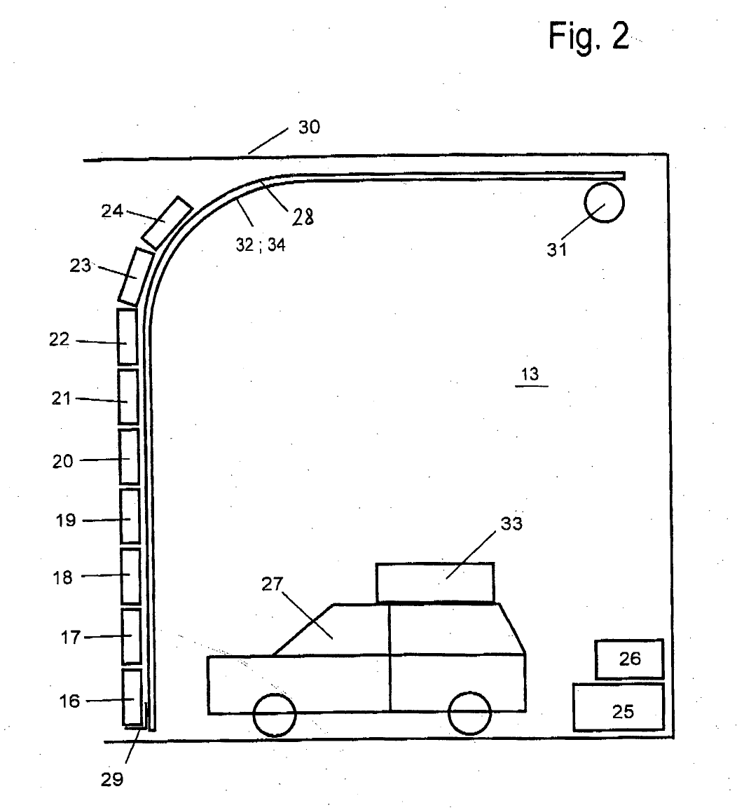

FIG. 2 a schematic illustration of a space closed by a sectional door,

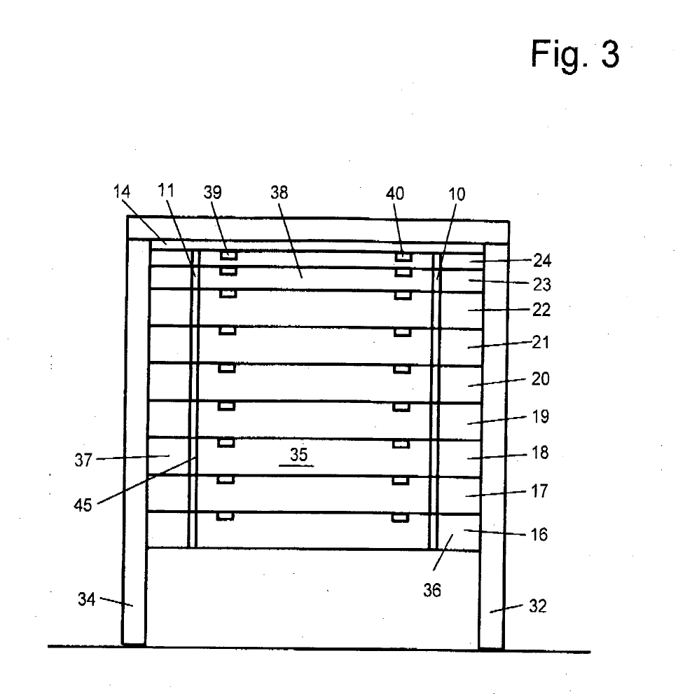

FIG. 3 a plan view of a building entrance which is closed with a sectional door;

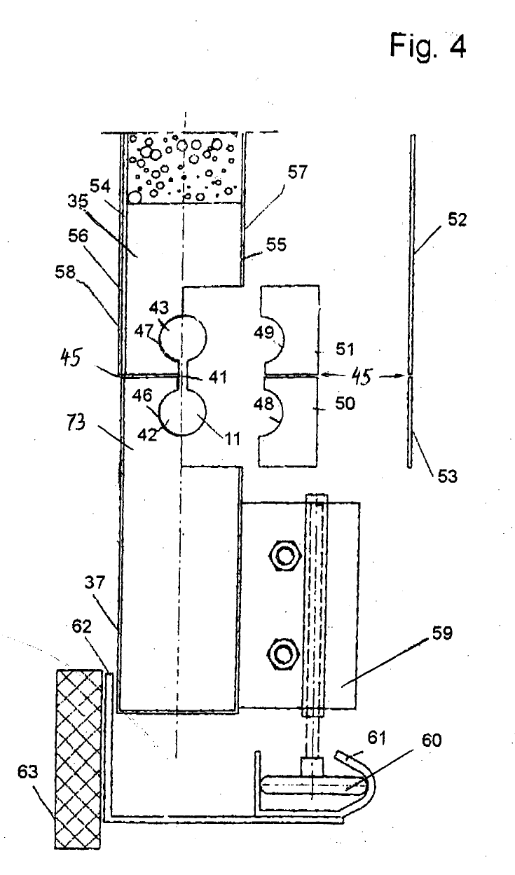

FIG. 4 a plan view of a left half of a section,

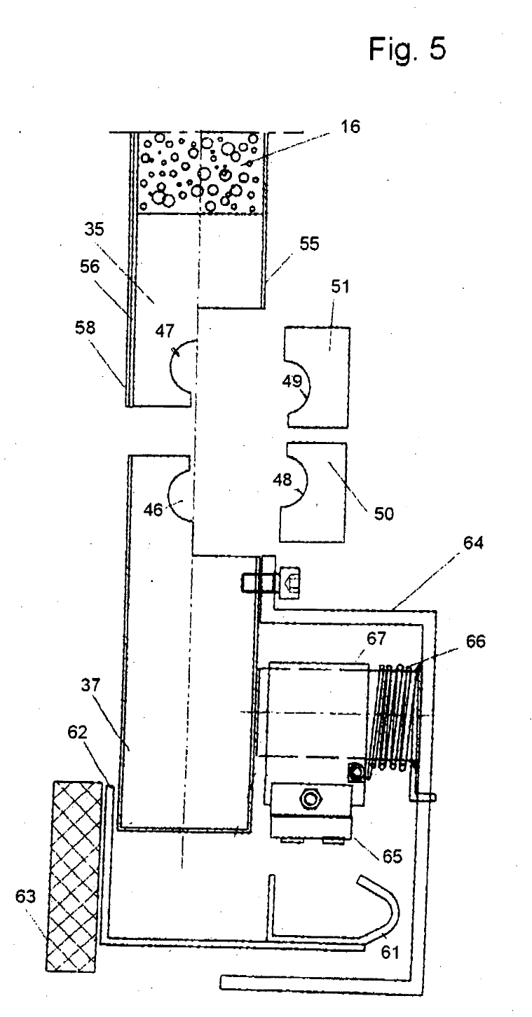

FIG. 5 a plan view of another left half of a section,

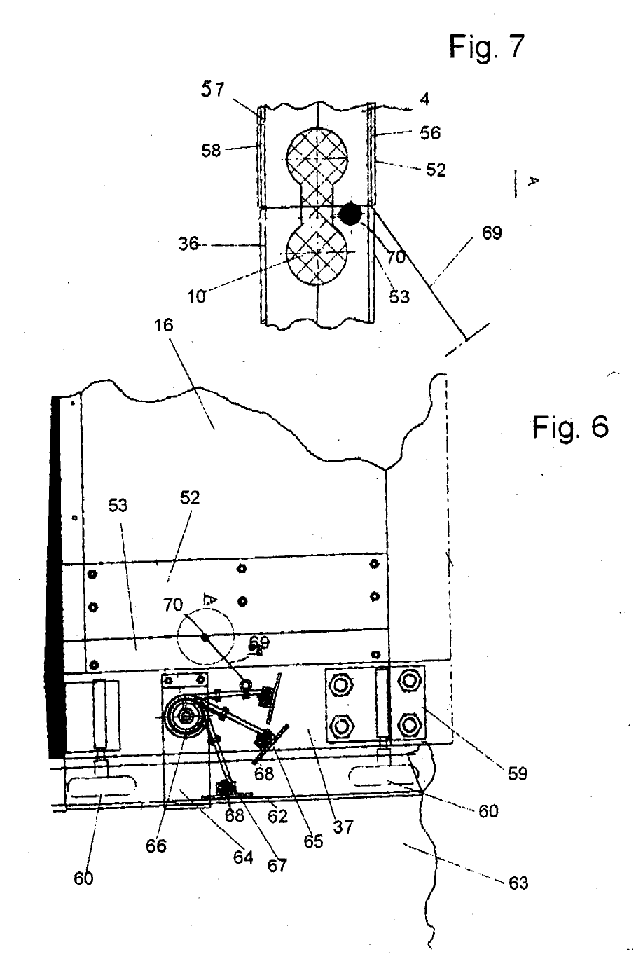

FIG. 6 a partial side view of a section guided in a rail,

FIG. 7 a section through a desired break point in the area A in FIG. 6,

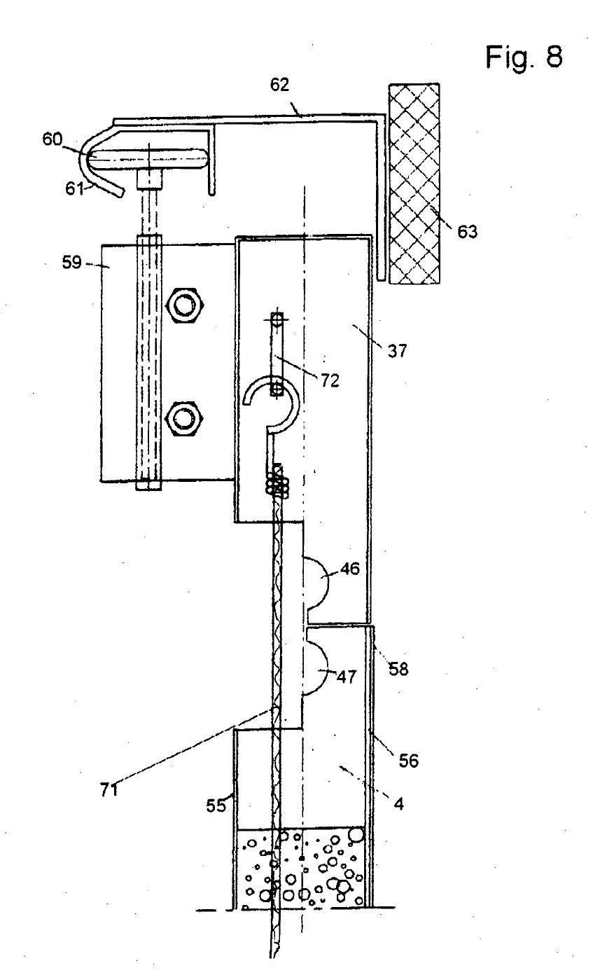

FIG. 8 a further plan view of a left half of a section, and

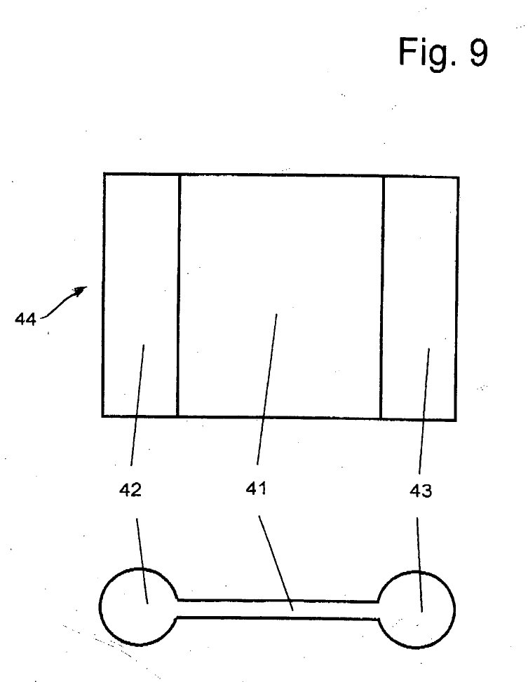

FIG. 9 a plan view of a desired break point configured as slat.

FIG. 1 illustrates a roadway 2 leading to a surface 1. The surface rises in the course of the roadway 2 and poses an end thereto. A vehicle 3 traveling the roadway approaches a surface portion 4 which is fitted in an opening 5 of the surface 1. The opening 5 is encircled by side edges 6, 7, and the surface portion 4 is encircled by side edges 8, 9. Extending between the side edges 6, 7 of the opening 5 and the side edges 8, 9 of the surface portion 4 from the surface 1 to the surface portion 4 is an unillustrated desired break point 10, 11 which yields in the event of an impact of the vehicle 3 upon the surface portion 4 so that the surface portion 4 separates from the opening 5. The desired break point 10, 11 is so dimensioned with respect to its durability that an impact of the vehicle 3 does not result in great damage to the surface portion 4 or to the vehicle 3. The surface portion 4 is secured to the surface 1 by a loose mounting 12 so that the surface portion 4 remains in its vertical disposition, when the desired break point 10, 11 ruptures, and cannot drop onto the vehicle 3.

The space 13 depicted in FIG. 2 has an opening 14 which is closed by a sectional door 15. This sectional door 15 is comprised of individual sections 16, 17, 18, 19, 20, 21, 22, 23, 24 arranged below one another and extending in longitudinal direction transversely to the opening 14. The space 13 is used, for example, as storage space for stacking goods 25, 26 which can be loaded onto an automobile 27 and transported through the opening 14.

The individual sections 16, 17, 18, 19, 20, 21, 22, 23, 24 can be lifted by a lifting device 28 having a gripper 29 for grabbing under the lowermost section 16. Located within this space 13 under its roof 30 is a lifting device 31 by which the section 16 is pressed against the section 16, 17, 18, 19, 20, 21, 22, 23, 24 arranged above it. As a consequence of this pressure, the sections 16, 17, 18, 19, 20, 21, 22, 23, 24 move along a rail 32 underneath the roof 30 until the opening 14 is cleared for passage of the automobile 27 which can then pass the opening 14.

Should the automobile 27 fail to wait long enough until all sections 16, 17, 18, 19, 20, 21, 22, 23, 24 have been pushed under the roof 30, there is the possibility of a contact with a bottom edge of a section 16 not yet withdrawn from the opening 14, when passing the opening 14, especially in the presence of a superstructure 33, so that in dependence on the intensity of the impact upon the section 16, the section 16 is at least severely damaged, possibly even split. In this damaged state, the section becomes stuck in the area of at least one of both opposite rails 32, 34. In this jammed state, the section 16 can no longer be elevated further away from the opening 14. A lowering of the sectional door 15 becomes also impossible as a result of the blockage in the rail 16 so that the space 13 has to remain in a semi-open state until the section 16 and possibly the rail 32, 34, which may have become useless as a result of the jammed section 16, are repaired. In the event goods of high value are stored in the space 13, it is required to guard the space for as long as the sectional door 15 is immobile. At the same time, the automobile 27 may no longer be utilized because it is unable to pass underneath the jammed section 16. In order to prevent such an cost-intensive shutdown in the operation of the sectional door 15, the individual sections 16, 17, 18, 19, 20, 21, 22, 23, 24 are provided with a surface portion 35 which is demarcated on both sides by end caps 36, 37. The end caps 36, 37 are guided on the rails 32, 34 and connected via desired break points 36, 37 with the surface portions 35. These surface portions 35 are configured as a mid-portion 38 which covers the substantial length of the sections 16, 17, 18, 19, 20, 21, 22, 23, 24. The mid-portions 38 of the subjacent sections are respectively interconnected by yielding hinges 39, 40 so that the mid-portions 38 are prevented from dropping down when the mid-portion 38 separates from both end caps 36, 37 but rather are secured yieldingly to the respectively neighboring sections 16, 17, 18, 19, 20, 21, 22, 23, 24.

As shown in FIG. 4 by way of an enlarged plan view of a left half of a section 16, 17, 18, 19, 20, 21, 22, 23, 24, the desired break point 11 is configured as a web 41 disposed between the surface portion 35 and the end cap 37 and having two opposite ends 42, 43 having each a circular cross section. The web 41 with its both circular ends 42, 43 defines a slat 44 of a length corresponding to the height of a section 16, 17, 18, 19, 20, 21, 22, 23, 24. This slat 44 is situated in corresponding configurations at the transition 45 between an end cap 37 and the surface portion 35. Provided in the surface portion 35 and in the end cap 37 are semicircular recesses 46, 47 which define with corresponding semicircular recesses 48, 49 of clamping pieces 50, 51 a circular cross section in which the ends 42, 43 of the slat 44 fit. It should be noted hereby that the web 41 has a thickness by which each of the semicircular recesses 46, 47, 48, 49 deviates from a half-circle.

After the slat 44 has been placed in the semicircular recesses of the surface portion 35 and the end cap 37 as well as also of the clamping pieces 50, 51, the clamping pieces 50, 51 are screwed together with the surface portion 35 and the end cap 37. To stiffen the connection between the clamping pieces 50, 51, on one hand, and the end cap 37 and the surface portion 35, on the other hand, a large inner cover sheet 52 is screwed to the surface portion 35 and the associated end cap 37, and a small inner cover sheet 53 is screwed to the end cap 37 and the associated clamping piece 50. The small inner cover sheet 53 is screwed to the clamping piece 50 and the end cap 37 across the entire height of each section 16, 17, 18, 19, 20, 21, 22, 23, 24. A narrow gap remains as transition 45 between the small inner cover sheet 53 and the large inner cover sheet 52.

In order to protect the surfaces 54, 55 of the sections 16, 17, 18, 19, 20, 21, 22, 23, 24, which surfaces face a possible impact, against mechanical deformations as a result of an impact, the surfaces are each provided with a coating 56, 57 of plastic, e.g. known under the trademark Makrolon. Furthermore, an outer cover sheet 58 extends on top of this coating 56.

The end caps 36, 37 of neighboring sections 16, 17, 18, 19, 20, 21, 22, 23, 24 are mechanically connected to one another such that they can be deflected via the curved rail 32 from the vertical direction in the area of the opening 14 into the horizontal direction underneath the roof 30. Furthermore, each of the end caps 36, 37 is connected to a roller holder 59 which rotatably supports a roller 60 to guide a section 16, 17, 18, 19, 20, 21, 22, 23, 24, This roller 60 is guided in a C-profile 61 which has an end in the form of a angle profile 62 and is covered by a door frame.

Furthermore, a locking mounting 64 is firmly connected to the end caps 36, 37 for support of a locking brake 65. This locking brake 65 is loaded by a spring 66 which acts on a locking arm 67 in the direction of the angle profile 62, when the locking brake 65 is engaged. As a result, the locking arm 67 is pressed against the angle profile 62 with a contact surface 68 to such a degree that the damaged section 16, 17, 18, 19, 20, 21, 22, 23, 24 can no longer move within the rail 34.

When the section 16, 17, 18, 19, 20, 21, 22, 23, 24 is undamaged, the locking brake 65 is blocked by a cable holder 69 which is held by a trigger 70 in the area of the desired break point at the transition 45 between the surface portion 4 and the end cap 36. A rupture of the desired break point 10 liberates the trigger 70 so that the spring 66 is able to pivot the locking brake 65 into the braking position, depicted in FIG. 6, in which the locking arm 67 engages the angle profile 62 to thereby prevent a lifting of the sectional door 15 under the influence of the lifting device 28. In this position of the sectional door 15, the large inner cover sheet 52 and the small inner cover sheet 53 can be unscrewed from the respective section 16, 17, 18, 19, 20, 21, 22, 23, 24. Then, the clamping pieces 50, 51 are loosened to allow removal of the ruptured desired break point from the semicircular recesses 46, 47 of the end caps 36, 37 and replacement by an unbroken desired break point 10, 11. The latter is then acted upon again by the clamping pieces 50, 51 which in turn are secured by means of the inner cover sheets 52, 53. At the same time, the trigger 70 is secured again in the gap 45, while the cable holder 69 is tightened so that the locking brake 65 clears again the movement of the section 16, 17, 18, 19, 20, 21, 22, 23, 24.

The surface portion 4 freely swings on a neighboring section 16, 17, 18, 19, 20, 21, 22, 23, 24 after rupture of the desired break point. The swing of the surface portion 4 as a result of the impact can be damped by providing a cable pull 71 which extends across the section and is under a certain tension as a consequence of its securement in a mounting 73. The surface portion swings against this cable pull 71 after rupture of the desired break point 10, 11, so that the swing of this surface portion 4 is damped.

The skilled artisan will, of course, recognize that a similar construction as described for section doors is equally applicable for rolling doors and its elements. This construction can hereby be applied also to sections or elements which extend in vertical plane, and not, as described here, in horizontal plane.

1. (canceled)

2. The method of claim 34, wherein the surface portion is separated from the surface upon impact.

3. The method of claim 2, wherein the surface portion separated from the surface is held yieldingly on the surface.

4. The method of claim 34, wherein the surface is deformed in the region of a transition from the surface to the surface portion impact.

5. The method of claim 4, and further comprising the steps of deforming upon impact in the region of the transition a connecting means, which is easy to replace and connects the surface portion to the surface, and replacing the deformed connecting means by a new said connecting means, when the surface portion is reinserted.

6. The method of claim 34, wherein the surface portion, damaged by the impact, is replaced by a replacement portion.

7. The method of claim 34, wherein the surface is a door having sections that move relative to one another in an opening direction of the door, each section having two end zones guided in rails and shortened by an end and further comprising the steps of securing a field element to each of both sides of the surface portion remaining of the section for receiving a desired break point, and connecting the field element via the desired break point with an end cap which is mechanically connected to a section, arranged above or, optionally below, and is guided in a neighboring one of the rails.

8. A door for separating neighboring spaces, comprising a door surface, which is moveably arranged between the spaces to clear or close an opening between the spaces in dependence on a disposition of the door, said door body having a surface portion which is provided in a direction of an object moving towards the opening and so yieldingly secured in the door surface as to fall out from the door surface in the event of an impact of the object.

9. The door of claim 8, wherein the surface portion falling out from the door surface is reinsertable in the door surface after removing the object.

10. The door of claim 8, wherein the surface portion separates from the door surface when a predetermined impact force of the object is exceeded.

11. The door of claim 10, wherein the surface portion, when separating from the door surface, is held captive to the door surface.

12. The door of claim 8, wherein the surface portion is connected via a desired break point with the door surface.

13. The door of claim 12, wherein the desired break point is configured in the form of a web extending between neighboring edges of the door surface, on one hand, and the surface portion, on the other hand, and rupturing when the predetermined impact force of the object is exceeded.

14. The door of claim 13, wherein the web ruptures when the impact force on the surface portion exceeds 110 kp.

15. The door of claim 13, wherein the web has two opposite ends of thickened cross sections, each said end guided in complementary recesses of the door surface and the surface portion.

16. The door of claim 13, wherein the web is provided on both ends with thickened areas of circular cross section.

17. The door of claim 16, wherein the web with its thickened ends forms a slat which extends through the neighboring edges of the surface portion, on one hand, and the door surface, on the other hand.

18. The door of claim 17, further comprising clamping pieces constructed for connection to the edges of the door surface and the surface portion and having semicircular recesses, wherein the edges of the door surface as well as of the surface portion are provided with semicircular recesses, which form with the semicircular recesses of the clamping pieces circular guides for receiving the circularly thickened ends of the webs.

19. The door of claim 18, wherein the slat extends with the circularly thickened ends of its cross section in circular cross sections, which are comprised of opposing semicircular recesses extending in the edges of the door surface, and the surface portion (4) and of the semicircular recesses of the clamping pieces.

20. The door of claim 8, wherein the door surface is comprised of elements which move relative to one another and which are movably guided on at least one vertical rail below a ceiling of one of both spaces, each element configured in midsection to form the surface portion which is bounded on opposite sides by end caps and is connected to the end caps via desired break points.

21. The door of claim 20, wherein the end caps are each guided via rollers in a respective rail.

22. The door of claim 20, wherein the elements are sections of a sectional door, at least one of the sections being constructed to have the surface portion which yields to pressure.

23. The door of claim 20, wherein the surface portions of neighboring elements have a yielding connection to prevent the surface portions, when separating from the elements upon impact and rupture of the desired break point from falling down.

24. The door of claim 20, and further comprising a locking brake disposed within a door frame for slowing down the end caps of each element.

25. The door of claim 24, wherein the locking brake includes a spring-loaded arm which firmly engages the door frame after the desired break point ruptures.

26. The door of claim 25, further comprising a trigger arranged in an area of the desired break point and released, when the desired break point ruptures to thereby release a spring to actuate the locking brake.

27. The door of claim 26, wherein the spring-loaded arm of the locking brake generates a braking effect to prevent the door surface from inadvertently moving up as a result of the spring load.

28. The door of claim 20, further comprising a damper is to prevent a swing of the surface portion after the desired break point ruptures.

29. The door of claim 28, wherein the damper is configured as a cable pull extending across the surface portion and secured to the opposing end caps.

30. The door of claim 8, further comprising a shock-resistant armoring for protecting at least one side of the surface portion against deformation.

31. The door of claim 30, wherein the armoring is realized by a plastic plate positioned anteriorly of the surface portion.

32. The door of claim 18, wherein the clamping pieces are secured by cover sheets which respectively cover opposing end portions of the end caps and of the surface portion.

33. The door of claim 26, wherein the trigger is connected to a switch which switches off an electric drive of the door.

34. A method for protecting a surface from impact, comprising the steps of:
selecting in the surface a surface portion which may encounter an impact by an object;
inserting the surface portion in a yielding manner in the surface;
allowing the surface portion to be knocked out in the event of the impact;
reinserting the surface portion in the surface; and
connecting the surface portion to the surface.
